(19) United States
(12) Patent Application Publication
(10) Pub. No.: US 2017/0026541 A1
(43) Pub. Date: Jan. 26, 2017

(54) INFORMATION DISPLAY METHOD AND SURVEILLANCE SYSTEM

(71) Applicant: VIVOTEK INC., New Taipei City (TW)

(72) Inventors: Chih-Chiang Chen, New Taipei City (TW); Yui-Juin Liu, New Taipei City (TW)

(21) Appl. No.: 15/190,190

(22) Filed: Jun. 23, 2016

(30) Foreign Application Priority Data
Jul. 24, 2015 (TW) 104123970

(51) Int. Cl. H04N 1/32; G06F 3/0484; G06K 9/00

(52) U.S. Cl. CPC H04N 1/32128; G06K 9/00771; G06F 3/04842

(57) ABSTRACT

An information display method includes steps of capturing an image of a place; attaching a reference information to the image, wherein the reference information indicates an object information related to a target object in the place; and displaying the image with the reference information.

### BACKGROUND OF THE INVENTION

1. Field of the Invention

The invention relates to an information display method and a surveillance system and, more particularly, to an information display method and a surveillance system capable of attaching a reference information to a captured image.

2. Description of the Prior Art

Since safety awareness is being raised gradually, people pay much attention to safety surveillance application. So far in many public or non-public places, there are always one or more cameras installed for safety surveillance. When monitoring a place, it usually needs to estimate some information (e.g. size, distance, etc.) of a specific object in the monitored place in real time from an image captured by a camera. For example, when the camera takes a criminal stood in front of a bank counter, it needs to know the height or other related information of the criminal through image analysis, so as to provide the information for the police to arrest the criminal. However, in the prior art, the image captured by the camera does not provide any information (e.g. size, distance, etc.) of the specific object in the monitored place, such that a user cannot know the information of the specific object in the monitored place through the image captured by the camera immediately in real time.

### SUMMARY OF THE INVENTION

An objective of the invention is to provide an information display method and a surveillance system capable of attaching a reference information to a captured image, so as to solve the aforesaid problems.

According to an embodiment of the invention, an information display method comprises steps of capturing an image of a place; attaching a reference information to the image, wherein the reference information indicates an object information related to a target object in the place; and displaying the image with the reference information.

According to another embodiment of the invention, a surveillance system comprises a camera unit, a processing unit and a display unit. The camera unit is used for capturing an image of a place. The processing unit is coupled to the camera unit and used for attaching a reference information to the image, wherein the reference information indicates an object information related to a target object in the place. The display unit is coupled to the processing unit and used for displaying the image with the reference information.

As mentioned in the above, after capturing the image of the place, the invention attaches the reference information to the image first and then displays the image with the reference information. Accordingly, a user can know the object information related to the target object in the place through the image immediately in real time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a surveillance system according to an embodiment of the invention.

FIG. 2 is a schematic diagram illustrating the setting interface shown in FIG. 1.

FIG. 3 is a schematic diagram illustrating the setting interface shown in FIG. 2 changed from setting to display mode.

FIG. 4 is a schematic diagram illustrating the setting interface shown in FIG. 3 changed from environmental parameter setting to home.

FIG. 5 is a schematic diagram illustrating the setting interface shown in FIG. 3 changed from user select mode to default setting mode.

FIG. 6 is a schematic diagram illustrating the setting interface shown in FIG. 5 changed from environmental parameter setting to home.

FIG. 7 is a schematic diagram illustrating a setting interface according to another embodiment of the invention.

FIG. 8 is a schematic diagram illustrating the setting interface shown in FIG. 7 changed from setting to display mode.

FIG. 9 is a flowchart illustrating an information display method according to an embodiment of the invention.

### DETAILED DESCRIPTION

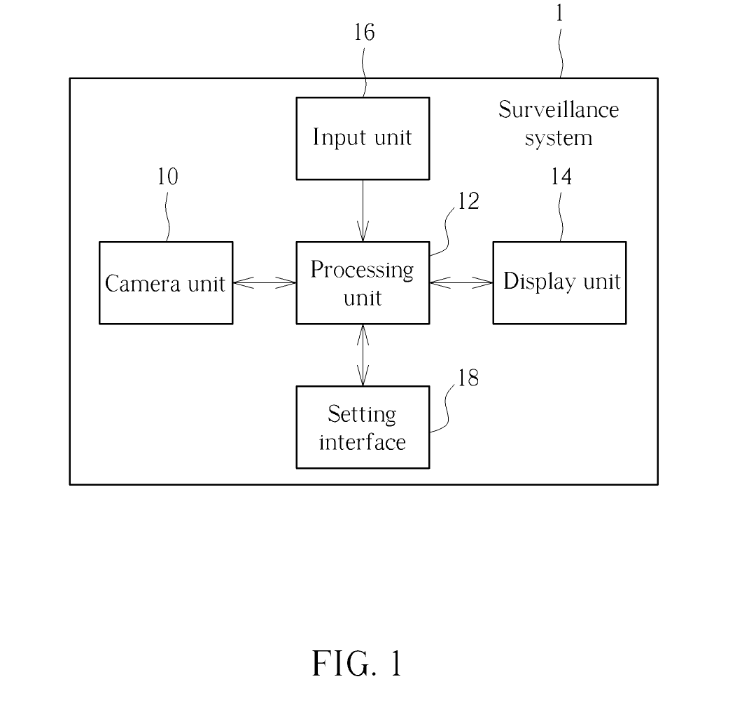

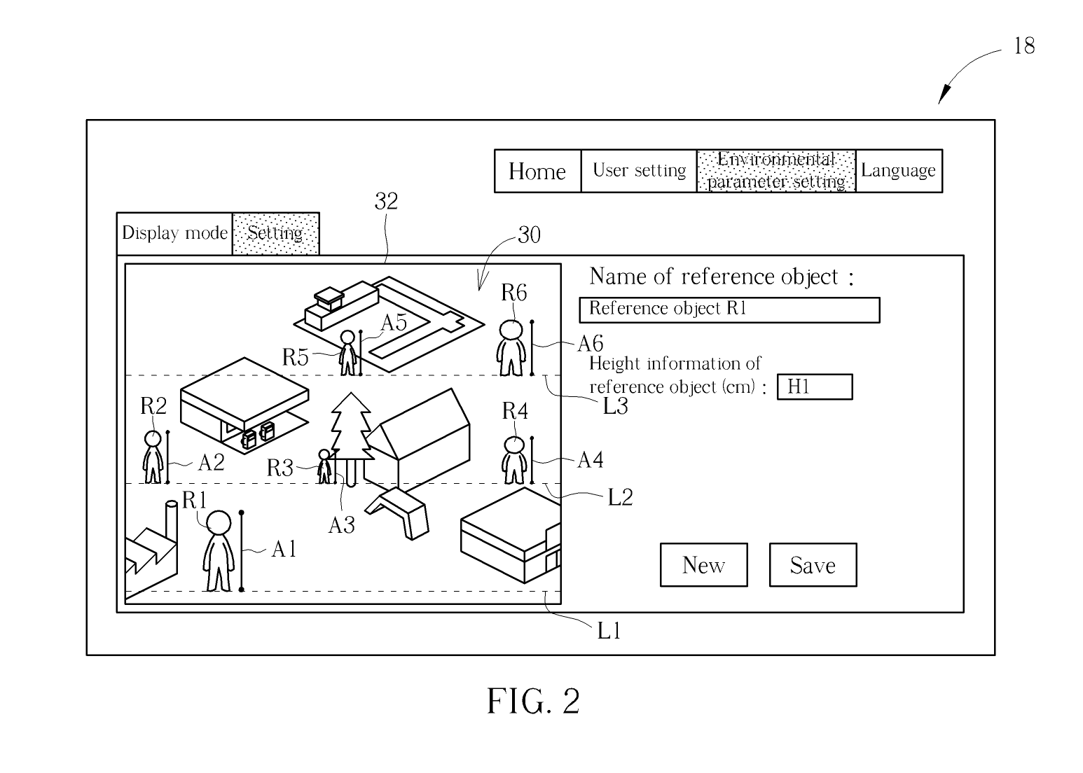

Referring to FIGS. 1 and 2, FIG. 1 is a functional block diagram illustrating a surveillance system 1 according to an embodiment of the invention and FIG. 2 is a schematic diagram illustrating the setting interface 18 shown in FIG. 1.

As shown in FIG. 1, the surveillance system 1 comprises a camera unit 10, a processing unit 12, a display unit 14, an input unit 16 and a setting interface 18, wherein the processing unit 12 is coupled to the camera unit 10, the display unit 14, the input unit 16 and the setting interface 18. In this embodiment, the camera unit 10 may be a charge coupled device (CCD) or a complementary metal-oxide-semiconductor (CMOS) light sensing component; the processing unit 12 may be a processor or a controller with data processing/calculation function; the display unit 14 maybe a liquid crystal display device, a plasma display device or other display devices; the input unit 16 may be a keyboard, a mouse or other input devices; and the setting interface 18 maybe implemented by software, firmware and/or hardware.

The camera unit 10 is used for capturing an image of a place. The setting interface 18 is used for receiving at least one reference object disposed in the place by a user and receiving a height information of the at least one reference object inputted by the user, wherein the at least one reference object is located at a horizontal line in the image. The setting interface 18 is displayed in the display unit 14 for the user to perform related setting.

As shown in FIG. 2, the image 32 of the place 30 captured by the camera unit 10 may be displayed in the setting interface 18. To attach a reference information to the image 32, the user may perform environmental parameter setting through the setting interface 18 first. When performing environmental parameter setting through the setting interface 18, the user may dispose at least one reference object in the place 30 in advance. In this embodiment, the user may dispose a plurality of reference objects R1-R6 with different heights in the place 30, wherein the reference objects R1-R6 are located at a plurality of horizontal lines L1-L3 in the image 32. As shown in FIG. 2, the reference object R1 is located at the horizontal line L1 in the image 32, the reference objects R2-R4 are located at the horizontal line L2 in the image 32, and the reference objects R5-R6 are located at the horizontal line L3 in the image 32. It should be noted that the aforesaid reference objects may be persons or other objects.

Afterward, the user may use the input unit 16 to input height information of the reference objects R1-R6 in the setting interface 18. As shown in FIG. 2, the user may input the height information (e.g. H1 cm) for the reference object R1 first, click “Save” button, and then click “New” button to input the height information for the other reference objects. Then, the processing unit 12 calculates a reference value per unit pixel of each horizontal line L1-L3 according to a pixel amount covered by each reference object R1-R6 in the image 32 and the height information of each reference object R1-R6.

In this embodiment, the user may use the input unit 16 to set reference lines A1-A6 corresponding to the reference objects R1-R6 in the image 32, wherein the lengths of the reference lines A1-A6 are corresponding to the lengths of the reference objects R1-R6 in the image 32. Accordingly, the processing unit 12 may calculate the pixel amount covered by each reference line A1-A6 in the image 32 to obtain the pixel amount covered by each reference object R1-R6 in the image 32. In another embodiment, the processing unit 12 may recognize the pixel amount covered by each reference object R1-R6 in the image 32 automatically through image recognition technology, such that the user needs not to set the reference lines A1-A6 as mentioned in the aforesaid embodiment.

Referring to Table 1 below, Table 1 shows the height information T1-T6 of each reference object R1-R6 and the pixel amount P1-P6 covered by each reference object R1-R6. In this embodiment, since there is only one reference object R1 located at the horizontal line L1, the reference value per unit pixel of the horizontal line L1 may be represented by H1/P1; since there are three reference objects R2-R4 located at the horizontal line L2, the reference value per unit pixel of the horizontal line L2 may be represented by (H2/P2+H3/P3+H4/P4)/3; and since there are two reference objects R5-R6 located at the horizontal line L3, the reference value per unit pixel of the horizontal line L3 may be represented by (H5/P5+H6/P6)/2. It should be noted that the user may dispose the reference object at other horizontal lines and the reference value per unit pixel of the other horizontal lines may be calculated by the aforesaid manner.

TABLE 1

| Reference | Height information | Pixel amount covered |
|---|---|---|
| object | of reference object | by reference object |
| R1 | H1 | P1 |
| R2 | H2 | P2 |
| R3 | H3 | P3 |
| R4 | H4 | P4 |
| R5 | H5 | P5 |
| R6 | H6 | P6 |

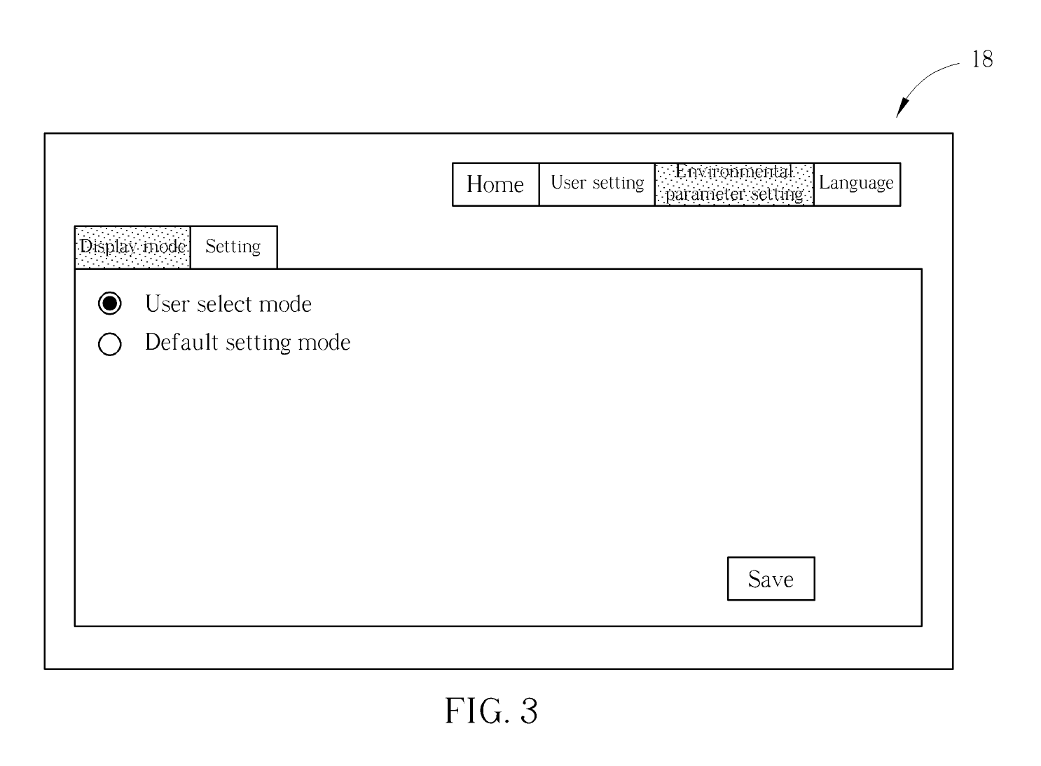

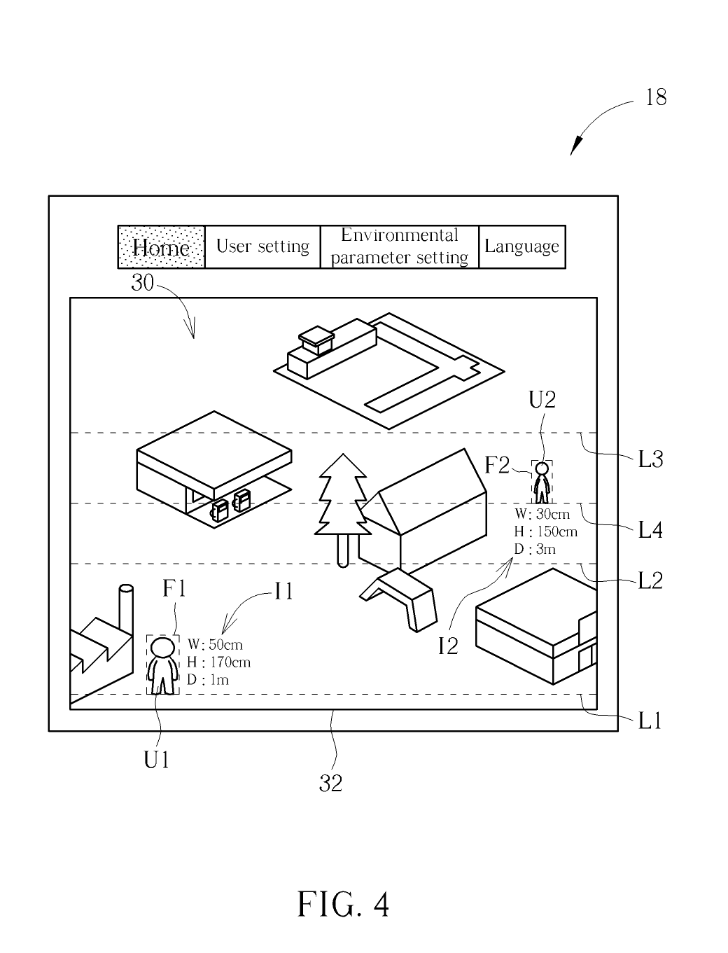

Referring to FIGS. 3 and 4, FIG. 3 is a schematic diagram illustrating the setting interface 18 shown in FIG. 2 changed from setting to display mode and FIG. 4 is a schematic diagram illustrating the setting interface 18 shown in FIG. 3 changed from environmental parameter setting to home. As shown in FIG. 3, the setting interface 18 may provide the display modes including “user select mode” and “default setting mode” for the user. After the user uses the input unit 16 to select “user select mode”, the setting interface 18 may be changed from environmental parameter setting to home. At this time, the display unit 14 displays the image 32 of the place 30 captured by the camera unit 10, as shown in FIG. 4. If the user wants to know an object information of a target object U1 in the place 30, the user may use the input unit 16 to select the target object U1 by a frame F1 in the image 32. Since the target object U1 is located at the horizontal line L1, the processing unit 12 will calculate a reference information I1 corresponding to the target object U1 according to the reference value per unit pixel H1/P1 of the horizontal line L1 after selecting the target object U1, wherein the reference information I1 is used for indicating the object information related to the target object U1 in the place 30. In this embodiment, the aforesaid object information may comprise any one of a height information H of the target object U1, a width information W of the target object U1, and a distance information D between the target object U1 and the camera unit 10, or a combination thereof.

In this embodiment, after selecting the target object U1 by the frame F1, the processing unit 12 may know a vertical pixel amount PV1 and a horizontal pixel amount PH1 covered by the frame F1. Therefore, the height information H of the target object U1 may be represented by PV1*H1/P1 and the width information W of the target object U1 may be represented by PH1*H1/P1. Furthermore, the distance information D between the target object U1 and the camera unit 10 may be derived from the position of the camera unit 10. After calculating the reference information I1, the processing unit 12 may attach the reference information I1 to the image 32 and display the image 32 with the reference information I1 in the display unit 14. In this embodiment, the reference information I1 may be displayed by, but not limited to, a combination of text and symbol. The display manner of the reference information I1 may be determined according to practical applications.

As shown in FIG. 4, a target object U2 is located at a horizontal line L4. When performing environmental parameter setting, the reference value per unit pixel of the horizontal line L4 does not be calculated. After the user selects the target object U2 by a frame F2, the processing unit 12 may use the reference value per unit pixel of the horizontal lines L2-L3 to calculate the reference value per unit pixel of the horizontal line L4 through interpolation method first and then calculate a reference information I2 related to the target object U2 according to the reference value per unit pixel of the horizontal line L4 and the aforesaid manner. It should be noted that the aforesaid target object may be a person or other objects.

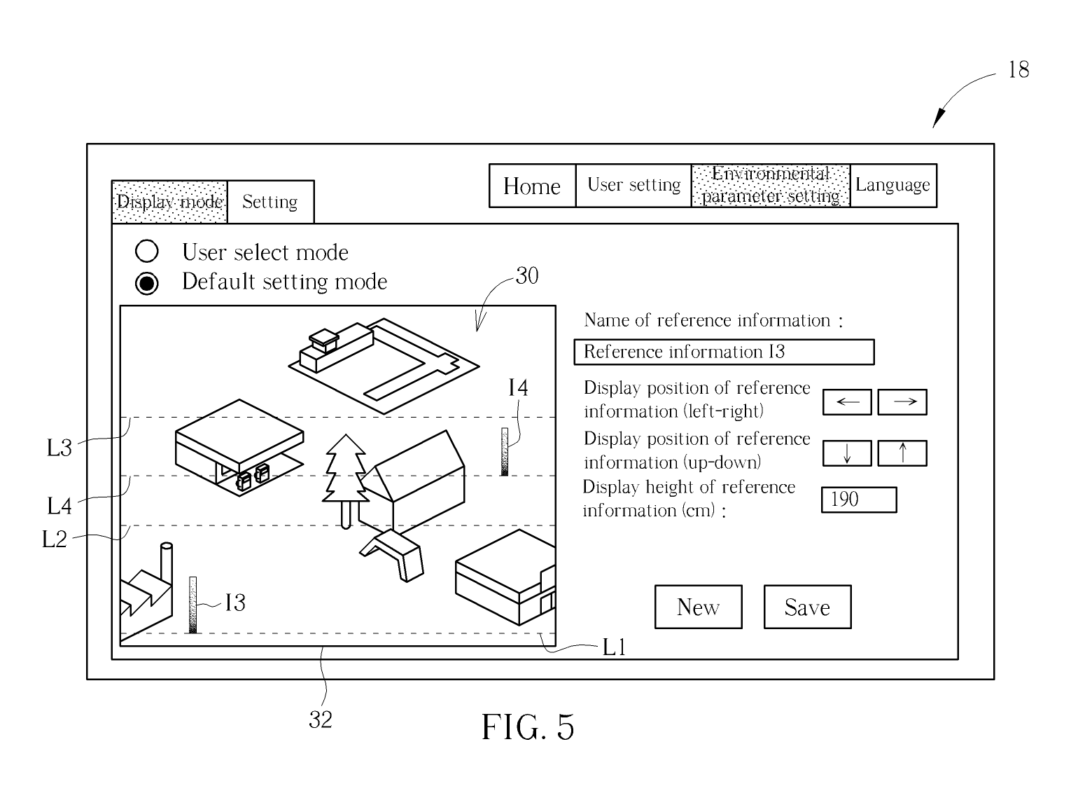

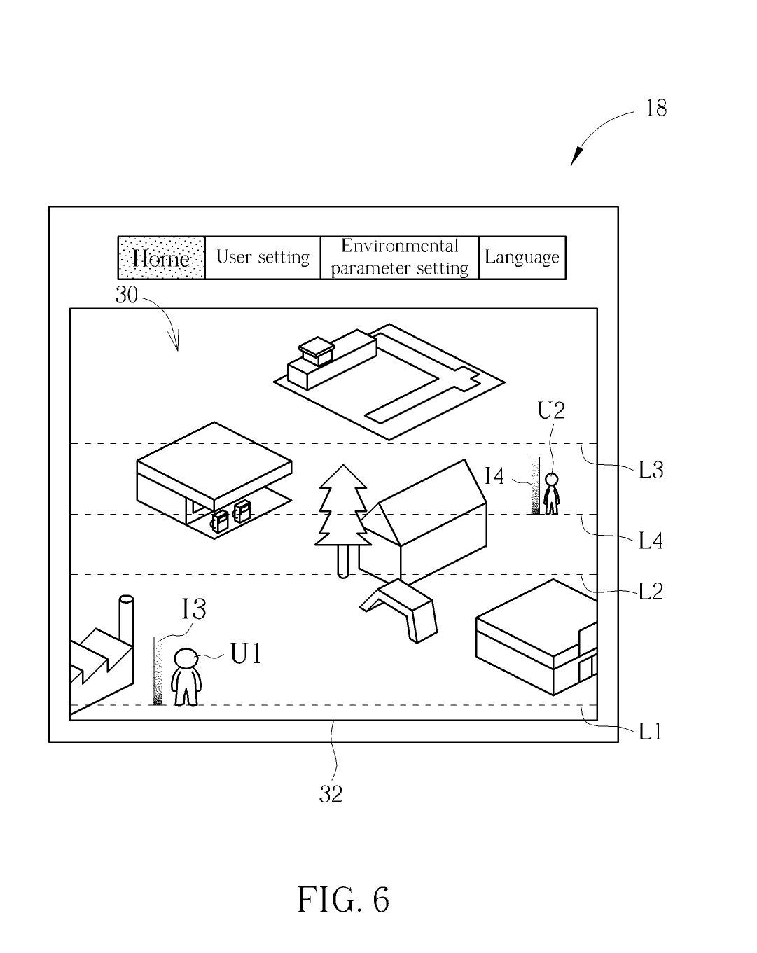

Referring to FIGS. 5 and 6, FIG. 5 is a schematic diagram illustrating the setting interface 18 shown in FIG. 3 changed from user select mode to default setting mode and FIG. 6 is a schematic diagram illustrating the setting interface 18 shown in FIG. 5 changed from environmental parameter setting to home. As shown in FIG. 5, after the user uses the input unit 16 to select “default setting mode”, the user may further set reference information I3-I4 at any position in the image 32. In this embodiment, the reference information I3-I4 may be displayed by, but not limited to, gradient pattern. The display manner of the reference information I3-I4 may be determined according to practical applications.

In this embodiment, the user may set a display position and a display height of the reference information I3-I4 in the setting interface 18. As shown in FIG. 5, the user may use the input unit 16 to click up, down, left and right buttons to set the display position of the reference information I3-I4. Furthermore, the user may set the display height of the reference information I3 to be 190 cm. Since the reference information I3 is located at the horizontal line L1 and the reference value per unit pixel of the horizontal line L1 is H1/P1, the processing unit 12 may take a pixel amount 190/(H1/P1) to be the display height of the reference information I3 in the image 32. Moreover, since the reference information I4 is located at the horizontal line L4, the processing unit 12 may use the reference value per unit pixel of the horizontal lines L2-L3 to calculate the reference value per unit pixel of the horizontal line L4 through interpolation method first and then calculate the display height of the reference information I4 in the image 32 according to the reference value per unit pixel of the horizontal line L4 and the aforesaid manner.

After setting the reference information I3-I4, the user may use the input unit 16 to change the setting interface 18 from environmental parameter setting to home. At this time, the display unit 14 will display the image 32 with the reference information I3-I4 after the aforesaid setting, as shown in FIG. 6. When the target object U1 is close to the reference information I3, the user may estimate the height information of the target object U1 by the color distribution of the gradient pattern of the reference information I3; and when the target object U2 is close to the reference information I4, the user may estimate the height information of the target object U2 by the color distribution of the gradient pattern of the reference information I4.

The aforesaid embodiments may be applied to various cameras.

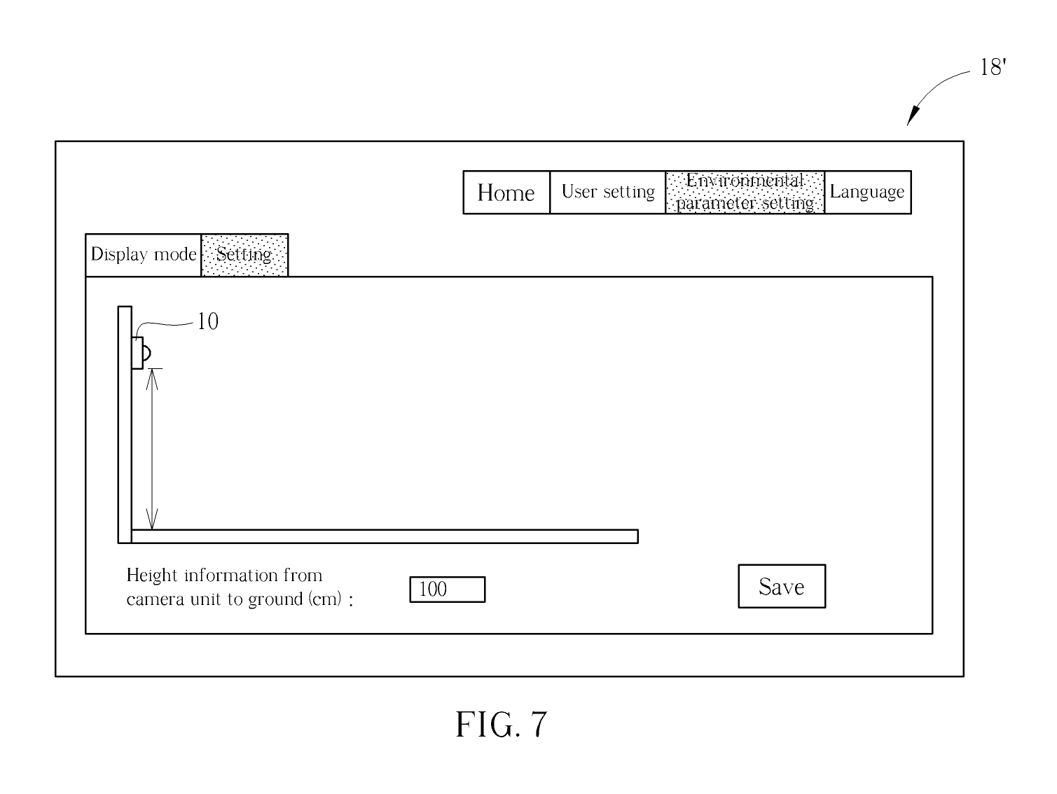

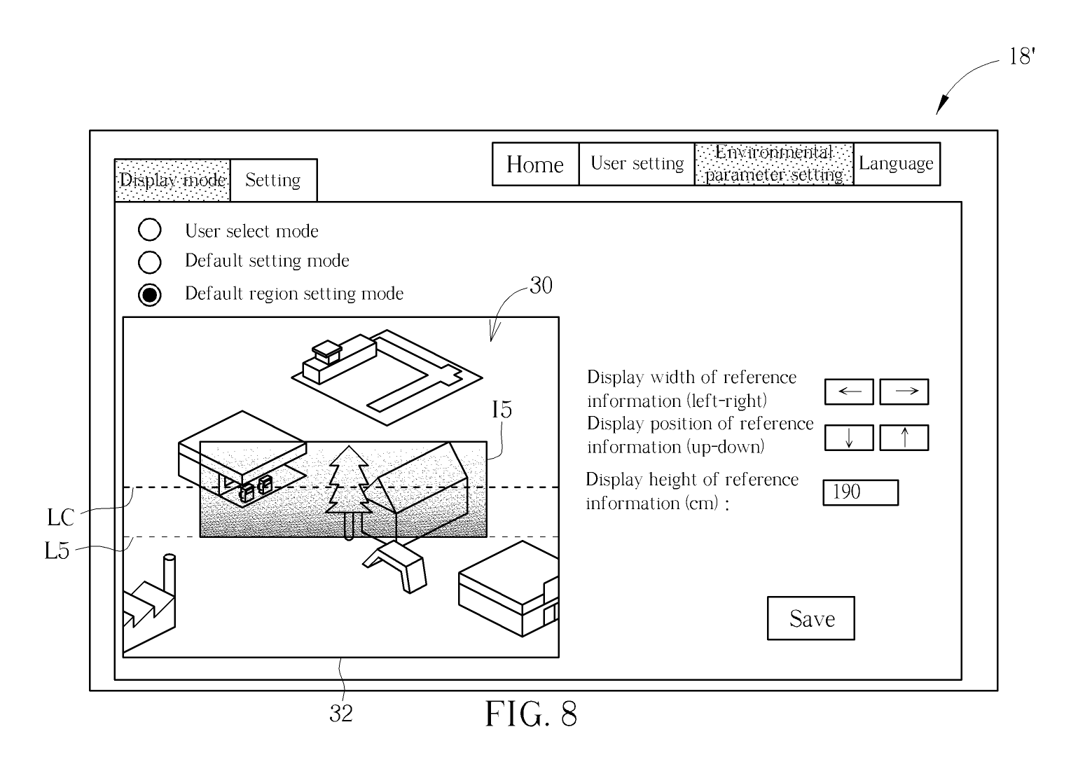

Referring to FIGS. 7 and 8, FIG. 7 is a schematic diagram illustrating a setting interface 18′ according to another embodiment of the invention and FIG. 8 is a schematic diagram illustrating the setting interface 18′ shown in FIG. 7 changed from setting to display mode. When the camera unit 10 of the invention is a wall-mount type camera unit, the user may input a height information (e.g. 100 cm) from the camera unit 10 to a ground in the setting interface 18′, as shown in FIG. 7. At this time, the processing unit 12 may calculate a reference value per unit pixel of at least one horizontal line in the image 32 according to the height information from the camera unit 10 to the ground and a central horizontal line LC of the image 32 and calculate the reference information according to the reference value per unit pixel of the at least one horizontal line. As shown in FIG. 8, the user may use the input unit 16 to set a reference information I5 at a horizontal line L5 and set the display height of the reference information to be 190 cm.

For the wall-mount type camera unit 10, after performing level calibration on the wall-mount type camera unit 10, a real distance between any horizontal line and the central horizontal line LC in the image 32 is equal to the height information from the camera unit 10 to the ground. Provided that the pixel amount covered by the distance between the horizontal line L5 and the central horizontal line LC is P7, and then the reference value per unit pixel of the horizontal line L5 is 100/P7. Since the display height of the reference information is set as 190 cm, the processing unit 12 may take the pixel amount 190/(100/P7) to be the display height of the reference information I5 in the image 32. Furthermore, the user may use the input unit 16 to click up, down, left and right buttons to set the display width and the display position of the reference information I5. When the display width and/or the display position of the reference information I5 is changed, the display shape of the reference information I5 will change correspondingly (e.g. become wider, narrower, longer and/or shorter).

In this embodiment, the reference information I5 is displayed by, but not limited to, a gradient pattern. The display manner of the reference information I5 may be determined according to practical applications. When the target object is close to the reference information I5, the user may estimate the height information of the target object by the color distribution of the gradient pattern of the reference information I5.

According to the embodiments shown in FIGS. 4, 6 and 8, the reference information of the invention may be displayed by any one of a text, a symbol and a pattern, or a combination thereof based on practical applications. Furthermore, the user may set any one of a display position, a display width, a display height and a display shape of the reference information, or a combination thereof according to different embodiments. It should be noted that the aforesaid horizontal lines L1-L5 and central line LC shown in the image 32 are used for illustration purpose only. In practical applications, the horizontal lines L1-L5 and central line LC will not be shown in the image 32.

In an embodiment of the invention, the camera unit may attach the reference information to the image first and then transmit the image with the reference information to a host device for display purpose. In another embodiment of the invention, the camera unit may transmit the image and the reference information to a host device, respectively, and then the host device may attach the reference information to the image and display the image with the reference information.

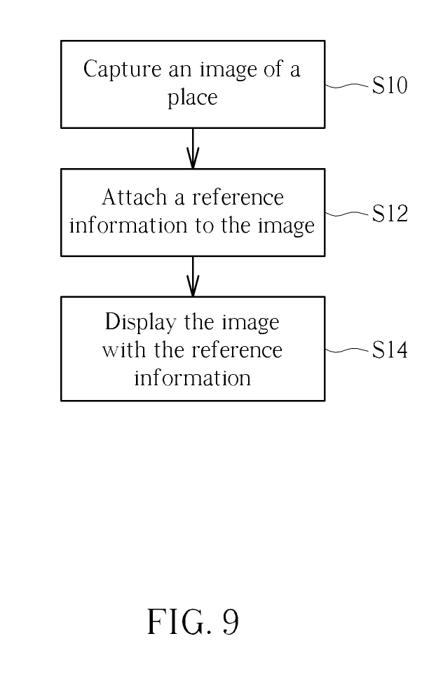

Referring to FIG. 9, FIG. 9 is a flowchart illustrating an information display method according to an embodiment of the invention. The information display method shown in FIG. 9 may be implemented by the aforesaid surveillance system 1. First of all, step S10 is performed to capture an image of a place. Afterward, step S12 is performed to attach a reference information to the image, wherein the reference information indicates an object information related to a target object in the place. Finally, step S14 is performed to display the image with the reference information. It should be noted that the detailed embodiments of the information display method of the invention are mentioned in the above and those will not be depicted herein again. Furthermore, the information display method shown in FIG. 9 may be implemented by software, firmware and/or hardware.

As mentioned in the above, after capturing the image of the place, the invention attaches the reference information to the image first and then displays the image with the reference information. Accordingly, a user can know the object information related to the target object (e.g. any one of the height information of the target object, the width information of the target object, and the distance information between the target object and the camera unit, or a combination thereof) in the place through the image immediately in real time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information display method comprising steps of:
capturing an image of a place;
attaching a reference information to the image, wherein the reference information indicates an object information related to a target object in the place; and
displaying the image with the reference information.

2. The information display method of claim 1, wherein the object information comprises any one of a height information of the target object, a width information of the target object, and a distance information between the target object and a camera unit capturing the image of the place, or a combination thereof.

3. The information display method of claim 1, wherein the reference information is displayed by any one of a text, a symbol and a pattern, or a combination thereof.

4. The information display method of claim 1, further comprising steps of:
after capturing the image of the place, allowing a user to select the target object in the image; and
after the user selects the target object in the image, attaching the reference information to the image.

5. The information display method of claim 1, further comprising steps of:
disposing at least one reference object in the place, wherein the at least one reference object is located at a horizontal line in the image;
inputting a height information of the at least one reference object in a setting interface;
calculating a reference value per unit pixel of the horizontal line according to a pixel amount covered by the at least one reference object and the height information of the at least one reference object; and
calculating the reference information according to the reference value per unit pixel of the horizontal line.

6. The information display method of claim 5, further comprising steps of:
disposing a plurality of the reference objects with different heights in the place, wherein the reference objects are located at a plurality of horizontal lines in the image;
inputting the height information of the reference objects in the setting interface;
calculating a reference value per unit pixel of each horizontal line according to the pixel amount covered by each reference object and the height information of each reference object; and
calculating the reference information according to the reference value per unit pixel of the horizontal lines.

7. The information display method of claim 1, further comprising steps of:
inputting a height information from a camera unit to a ground in a setting interface, wherein the camera unit captures the image of the place;
calculating a reference value per unit pixel of at least one horizontal line according to the height information from the camera unit to the ground and a central horizontal line of the image; and
calculating the reference information according to the reference value per unit pixel of the at least one horizontal line.

8. The information display method of claim 1, further comprising steps of:
allowing a user to set any one of a display position, a display width, a display height and a display shape of the reference information, or a combination thereof in a setting interface; and
displaying the image with the reference information after setting.

9. A surveillance system comprising:
a camera unit for capturing an image of a place;
a processing unit, coupled to the camera unit, for attaching a reference information to the image, wherein the reference information indicates an object information related to a target object in the place; and
a display unit, coupled to the processing unit, for displaying the image with the reference information.

10. The surveillance system of claim 9, wherein the object information comprises any one of a height information of the target object, a width information of the target object, and a distance information between the target object and a camera unit capturing the image of the place, or a combination thereof.

11. The surveillance system of claim 9, wherein the reference information is displayed by any one of a text, a symbol and a pattern, or a combination thereof.

12. The surveillance system of claim 9, further comprising:
an input unit coupled to the processing unit, the input unit allowing a user to select the target object in the image;
wherein after the user selects the target object in the image, the processing unit attaches the reference information to the image.

13. The surveillance system of claim 9, further comprising:
a setting interface, coupled to the processing unit, for receiving at least one reference object disposed in the place by a user and receiving a height information of the at least one reference object inputted by the user, wherein the at least one reference object is located at a horizontal line in the image;
wherein the processing unit calculates a reference value per unit pixel of the horizontal line according to a pixel amount covered by the at least one reference object and the height information of the at least one reference object and calculates the reference information according to the reference value per unit pixel of the horizontal line.

14. The surveillance system of claim 13, wherein the setting interface further receives a plurality of the reference objects with different heights disposed in the place by the user, the reference objects are located at a plurality of horizontal lines in the image, the setting interface further receives the height information of the reference objects inputted by the user, the processing unit calculates a reference value per unit pixel of each horizontal line according to the pixel amount covered by each reference object and the height information of each reference object and calculates the reference information according to the reference value per unit pixel of the horizontal lines.

15. The surveillance system of claim 9, further comprising:
a setting interface, coupled to the processing unit, for receiving a height information from the camera unit to a ground inputted by a user; and
the processing unit calculating a reference value per unit pixel of at least one horizontal line according to the height information from the camera unit to the ground and a central horizontal line of the image and calculating the reference information according to the reference value per unit pixel of the at least one horizontal line.

16. The surveillance system of claim 9, further comprising:
a setting interface, coupled to the processing unit, for receiving any one of a display position, a display width, a display height and a display shape of the reference information, or a combination thereof set by a user;
wherein the display unit displays the image with the reference information after setting.
